(19) United States
(12) Patent Application Publication
(10) Pub. No.: US 2010/0130278 A1
(43) Pub. Date: May 27, 2010

(54) WAGERING GAME MACHINE WITH CONTACTLESS POWER TRANSMISSION

(76) Inventors: Jorge Luis Shimabukuro, Las Vegas, NV (US); James M. Rasmussen, Chicago, IL (US); Craig J. Sylla, Round Lake, IL (US); John F. LaSalvia, Las Vegas, NV (US); Joseph Lane Spina, Las Vegas, NV (US)

Correspondence Address: SCHWEGMAN, LUNDBERG & WOESSNER/WMS GAMING, P.O. BOX 2938, MINNEAPOLIS, MN, 55402, US

(21) Appl. No.: 12/597,447

(22) PCT Filed: Apr. 15, 2008
(86) PCT No.: PCT/US08/04868

§ 371 Date: Oct. 23, 2009

Related U.S. Application Data
(60) Provisional application No. 60/913,705, filed on Apr. 24, 2007.

(51) Int. Cl. A63F 9/24; A63F 13/00

(52) U.S. Cl. 463/16; 463/30

(57) ABSTRACT

A computerized wagering game system includes a gaming module comprising gaming code which is operable to present a wagering game on which monetary value can be wagered, and a wireless power module. The power module is operable to provide power to a wagering game component via a power signal traveling through a nonconductive medium.

### RELATED APPLICATIONS

This patent application claims the priority benefit of U.S. Provisional Patent Application Ser. No. 60/913,705 filed Apr. 24, 2007 and entitled “CONTACTLESS POWER TRANSMISSION IN A WAGERING GAME MACHINE”, the content of which is incorporated herein by reference in its entirety.

### FIELD OF THE INVENTION

The invention relates generally to distributing power in a wagering game machine environment, and more specifically to contactless power transmission in a wagering game machine.

### Limited Copyright Waiver

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2007, 2008 WMS Gaming, Inc.

### BACKGROUND

Computerized wagering games have largely replaced traditional mechanical wagering game machines such as slot machines, and are rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they must be fair, they must provide sufficient feedback to the game player to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer or other game players to facilitate game play and to provide an entertaining game playing environment, but rely upon the presentation of the game and environment generated by the wagering game machine itself Incorporation of audio, video, and mechanical features into wagering game systems enhance the environment presented are therefore important elements in the attractiveness and commercial success of a computerized wagering game system. It is not uncommon for audio voices to provide instruction and help, and to provide commentary on the wagering game being played. A variety of complex graphics and video capabilities are also often provided via one or more specialized graphics processors, including the ability to decode and render full motion video, and to render complex three-dimensional graphics. Mechanical elements such as traditional slot machine reels are also incorporated into modern computerized wagering game machines to provide traditional or familiar elements to game players, or to add visual interest.

The variety of mechanical and electrical elements within a wagering game machine typically require electrical power to operate, which can become difficult to manage when a variety of wagering game system configurations are possible. Further, some items such as mechanical reels that have display elements on the reel strip or other such mechanical items can be difficult to power if they move during operation.

It is therefore desirable to manage power distribution in a wagering game machine.

### SUMMARY

One example embodiment of the invention comprises a computerized wagering game system including a gaming module comprising gaming code which is operable when executed on to conduct a wagering game on which monetary value can be wagered. The wagering game system also comprises a power module operable to provide power to a wagering game component via a power signal traveling through a nonconductive medium.

### BRIEF DESCRIPTION OF THE FIGURES

FIG. 1 shows a computerized wagering game machine, as may be used to practice some example embodiments of the invention.

FIG. 2 is a block diagram of a wagering game system, consistent with some example embodiments of the invention.

FIG. 3 illustrates a wagering game machine having a set top box with fish powered through a power signal traveling through a nonconductive medium, consistent with an example embodiment of the invention.

FIG. 4 illustrates a wagering game machine comprising a peripheral port operable to power a peripheral device via a power signal traveling through a nonconductive medium, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

One example embodiment of the invention comprises a computerized wagering game system including a gaming module comprising gaming code which is operable when executed on to conduct a wagering game on which monetary value can be wagered. The wagering game system also comprises an authentication module operable to authenticate one or more used partitions of a nonvolatile storage volume using a first authentication method and operable to authenticate one or more unused sections of the nonvolatile storage volume using a second authentication method. In some embodiments, this enables use of a variety of different storage volume sizes while keeping the used space and the used space's authentication data the same, and enables faster authentication of the unused space on the nonvolatile storage volume.

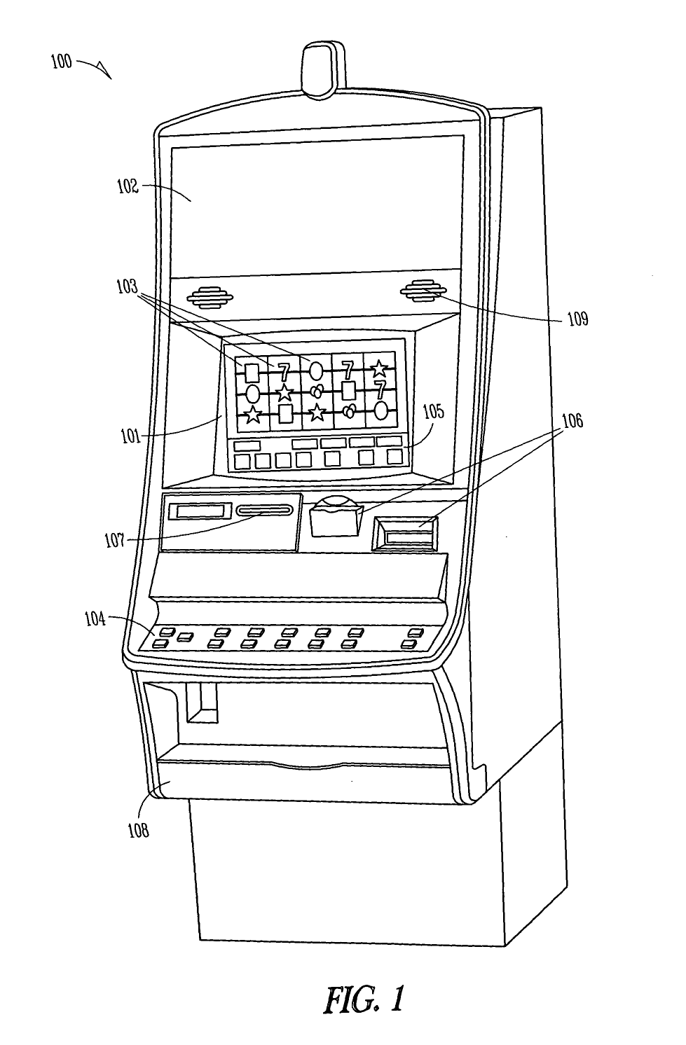

FIG. 1 illustrates a computerized wagering game machine, as may be used to practice some embodiments of the present invention. The computerized gaming system shown generally at 100 is a video wagering game system, which displays information for at least one wagering game upon which monetary value can be wagered on video display 101, and via top-box display 102. Video display 101 is in various embodiments a CRT display, a plasma display, an LCD display, a surface conducting electron emitter display, or any other type of display suitable for displaying electronically provided display information. Alternate embodiments of the invention will have other game indicators, such as mechanical reels instead of the video graphics reels shown at 103 that comprise a part of a video slot machine wagering game.

A wagering game is presented using software within the wagering game machine, such as through instructions stored on a machine-readable medium such as a hard disk drive or nonvolatile memory. In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The game of chance implemented via the loaded software takes various forms in different wagering game machines, including such well-known wagering games as reel slots, video poker, blackjack, craps, roulette, or hold 'em games. The wagering game is played and controlled with inputs such as various buttons 104 or via buttons 105 comprising part of a touchscreen overlay to video screen 101. In some alternate examples, other devices such as pull arm are used to initiate reel spin in this reel slot machine example are employed to provide other input interfaces to the game player.

Monetary value is typically wagered on the outcome of the games, such as with tokens, coins, bills, or cards that hold monetary value. The wagered value is conveyed to the machine through a changer 106 or a secure user identification module interface 107, and winnings are returned via the returned value card or through the coin tray 108. Sound is also provided through speakers 109, typically including audio indicators of game play, such as reel spins, credit bang-ups, and environmental or other sound effects or music to provide entertainment consistent with a theme of the computerized wagering game. In some further embodiments, the wagering game machine is coupled to a network, and is operable to use its network connection to receive wagering game data, track players and monetary value associated with a player, and to perform other such functions.

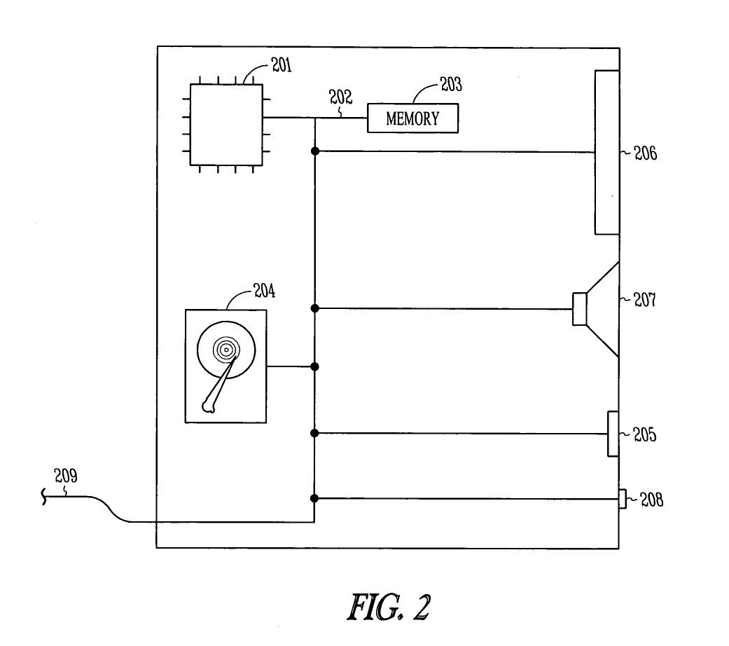

FIG. 2 shows a block diagram of an example embodiment of a wagering game system. The wagering game system includes a processor 201, which is sometimes called a microprocessor, controller, or central processing unit (CPU). In some embodiments, more than one processor is present, or different types of processors are present in the wagering game system, such as using multiple processors to run gaming code, or using dedicated processors for audio, graphics, security, or other functions. The processor is coupled via a bus 202 to various other components, including memory 203 and nonvolatile storage 204. The nonvolatile storage is able to retain the data stored therein when power is removed, and in various embodiments takes the form of a hard disk drive, nonvolatile random access memory such as a compact flash card, or network-coupled storage. Further embodiments include additional data storage technologies, such as compact disc, DVD, or HID-DVD storage in the wagering game system.

The bus 202 also couples the processor and components to various other components, such as a value acceptor 205, which is in some embodiments a token acceptor, a card reader, or a biometric or wireless player identification reader. A touchscreen display 206 and speakers 207 serve to provide an interface between the wagering game system and a wagering game player, as do various other components such as buttons 208, pullarms, and joysticks. A network connection 209 couples the wagering game system to other wagering game machines and to a wagering gape server, such as to provide downloadable games or to provide accounting, player tracking, or other functions. These components are located in a wagering game machine cabinet such as that of FIG. 1 in some embodiments, but can be located in multiple enclosures comprising a wagering game system or outside a wagering game machine cabinet in other embodiments, or in alternate forms such as a wireless or mobile device.

In operation, the wagering game system loads program code from nonvolatile storage 204 into memory 203, and the processor 201 executes the program code to cause the wagering game system to perform desired functions such as to present a wagering game upon which monetary value can be wagered. This and other functions are provided by various modules in the computerized system such as an audio module, a game presentation module, or a touchscreen display module, where such modules comprise in some embodiments hardware, software, mechanical elements, manual intervention, and various combinations thereof The wagering game machine is coupled to other wagering game machines, and to various other elements such as game servers, accounting servers, or community or progressive game servers via the network connection 209, and exchanges data with these machines via the network connection.

Some powered components of the wagering game machine are coupled via power cables and signal cables, as are traditionally used to couple various parts of an electronic or computerized wagering game system together. But, some components, such as the reels in a mechanical reel slot machine, are difficult to couple to power or signal cables due to their movement. Therefore, various embodiments of the invention comprise powering various components of the wagering game machine via one or more power signals that do not travel through a traditional conductive medium such as a copper wire. These power signals include in various embodiments broadcast, radiated, or inductively coupled electric or magnetic fields, light such as use of a bright light or laser, and other methods of nonconductive energy transfer.

Electric or magnetic energy transfer can take place through a number of related mechanisms. Electromagnetic induction is the method an electrical transformer uses to transfer energy from a primary coil to an electrically isolated secondary coil, and involves magnetic coupling of a field created in the primary coil to a secondary coil that is coupled to a circuit that draws power via the electromagnetic induction. Electronic devices such as powered toothbrushes also use electromagnetic induction to charge the rechargeable toothbrush when placed in the holder via electromagnetic induction, using a powered coil in the toothbrush base to couple with a coil in the toothbrush to recharge the toothbrush's battery. In both examples, a changing magnetic field generated by the powered or primary coil induces a voltage in the secondary coil that can be used to power a device coupled to the secondary coil without any conductive electrical connection between the circuit that powers the primary coil and the circuit being powered by the secondary coil.

A variety of other examples of electromagnetic coupling exist, including resonant coupling in which the primary and secondary coils are tuned to the same frequency, and where the primary coil may further be driven by a rectangular or square wave rather than a more traditional sine wave to enable coupling between the primary and secondary coils over distances up to several meters.

Electric fields, such as radio waves, are also used in some embodiments to transfer energy from a wagering game system to a wagering game component. In one example, electromagnetic radiation much like radio waves or microwaves are either broadcast or focused toward a wagering game component to receive the electromagnetic radiation and use the received radiation to power one or more electronic circuits within the wagering game component. Specialized antennas are used in some embodiments to provide efficient transmission of electromagnetic energy, and to transmit the electric field radiation in a desired direction with a desired dispersion pattern. In a further embodiment, the electromagnetic radiation is contained to a region of the wagering game machine, such as a peripheral device bay or a top box assembly, to prevent undesired transmission of electromagnetic radiation to the game players or outside the wagering game system.

Electromagnetic radiation is sometimes considered to include light, which can alternatively be considered its own class of wireless energy transfer. In one example, a bright visible light is directed or focused toward a peripheral device operable to convert the light energy to electrical power, such as via a solar cell or other such component. In another embodiment, a laser is used to send a power signal wirelessly to the wagering game component, which receives the laser signal and converts the coherent light to electrical power used to drive a circuit within the component. More sophisticated light power transfer systems use quantum cascade lasers and high efficiency solar cells to improve the efficiency of power transfer.

Still other technologies are emerging, and are anticipated to be appropriate for wireless power transfer consistent with some embodiments of the invention. One example is known as evanescent wave coupling, in which an electromagnetic wave is caused to couple or tunnel from a transmitting waveguide to a receiving waveguide. Research suggests that by sending an electromagnetic wave around an angular waveguide, the electromagnetic wave can be caused to couple with the receiving waveguide, where they can be rectified to produce a direct current power signal. In another example, electrical energy is transferred through nonconductive media via conduction, such as by creating a voltage field in air, water, or another nonconductive medium or by causing a nonconductive medium to exceed its breakdown voltage and conduct.

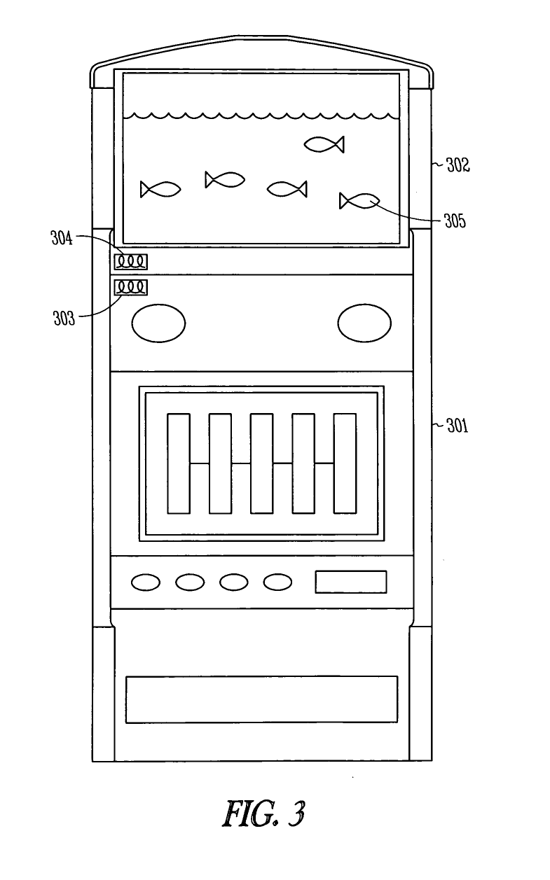

Each of these examples illustrates a way in which a power signal can be transferred from a wagering game machine to a peripheral device in the wagering game machine, such as may be desired where the peripheral device is able to move, or is otherwise desirably not electrically coupled to the wagering game system. One such example is shown in FIG. 3, which illustrates a wagering game machine having a set top box with fish powered through a power signal traveling through a nonconductive medium, consistent with an example embodiment of the invention. In this example, a wagering game cabinet 301 is much like the wagering game system shown in FIG. 1, but includes a top box 302 that is located on top of the wagering game cabinet. A coil 303 in the wagering game system inductively couples the wagering game system to a secondary coil 304 in the top box 304, thereby powering the circuits in the top box. The top box itself is in this example related to a fishing game, and has a number of fish 305 swimming in water. The fish are powered via at least one of light, electromagnetic radiation, or inductive coupling to a transmitter implanted within the top box 302, and use the power to swim around the top box assembly. The top box is selectively lit based on its use in game play, such as for use in a bonus game. In a more detailed example, the powered fish also receive a control signal such as a radio signal, and are able to perform actions at the direction of the control signal, such as to swim up or down in the water, or to designated locations such as by changing buoyancy or attraction or repulsion to a magnetic field by changing orientation of a magnet in the fish.

Other examples include other moving game elements, such as the more traditional reel strips as shown in FIG. 1. In one example, the reel strips themselves comprise an electronic display, which is powered via a wireless power method as described above. Spinning roulette wheels, dice that move and display selected numbers, and other more traditional wagering game elements are also within the scope of the invention, and can be powered via wireless power methods or systems such as are described herein. The power is used in various embodiments to power motion of the game element, to power a display on the game element, or to power communication between the game element and the wagering game system.

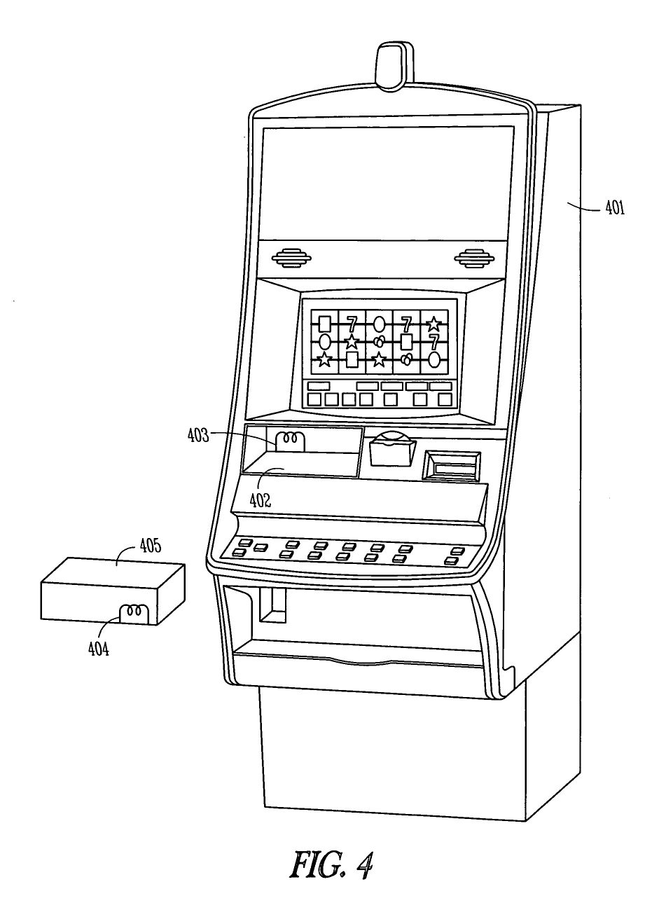

FIG. 4 illustrates a wagering game machine comprising a peripheral port operable to power a peripheral device via a power signal traveling through a nonconductive medium, consistent with an example embodiment of the invention. In this example, a port in the wagering game machine 401 such as was shown in FIG. 1 is operable to physically receive a wagering game peripheral device. The device is in some embodiments a device internal to the wagering game, such as a player tracking card reader or a ticket printer, and in other embodiments is operable to receive other peripheral devices such as a user-supplied media player or a portable wagering game device. The peripheral port 402 comprises in this example a coil 403 that is driven by a low current power signal when no peripheral device is detected, and is switched to higher current capability when a peripheral device is present. The field created by the primary coil 403 is coupled to a secondary coil 404 in the peripheral device 405 when the peripheral device is inserted in the wagering game machine's peripheral device port, providing power from the wagering game machine to the peripheral device.

The peripheral device is detected in some embodiments by physically detecting the presence of a peripheral device in the wagering game's peripheral port, and in an alternate embodiment is detected by exchange of data such as via a wireless communication system or by the current drawn through the primary coil in the wagering game system.

Communication between the wagering game machine and the peripheral device is provided in some embodiments through a wireless data communication method, such as via Bluetooth, wireless network, or other radio communication. In another example, and optical connection between the wagering game system and the peripheral device provides for the exchange of data, such as a digital optical coupling such as an optocoupler, an infrared port, or an optical digital audio connection.

Although the examples given here have illustrated a variety of applications for using various types of wireless power transfer in a wagering game system, the invention is not so limited. Various embodiments will include a wide variety of types of wagering game elements or peripheral devices, and a wide variety of wireless power methods and systems. Specific embodiments have been illustrated and described herein, but it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A computerized wagering game system, comprising:
a wagering game module operable to present a wagering game upon which monetary value can be wagered; and
a power module operable to provide power to a wagering game component via a power signal traveling through a nonconductive medium such that the power signal is used to provide electrical power to operate the component.

2. The computerized wagering game system of claim 1, wherein the power signal comprises an electric field.

3. The computerized wagering game system of claim 1, wherein the power signal comprises a magnetic field

4. The computerized wagering game system of claim 1, wherein the power signal comprises light.

5. The computerized wagering game system of claim 1, wherein the power signal comprises evanescent waves.

6. The computerized wagering game system of claim 1, wherein the wagering game component comprises a top-box.

7. The computerized wagering game system of claim 1, wherein the wagering game component comprises a moving electromechanical element.

8. The computerized wagering game system of claim 1, wherein the wagering game component comprises a wagering game peripheral device.

9. A method of operating a wagering game system, comprising:
presenting a wagering game upon which monetary value can be wagered; and
providing power to a wagering game component via a power signal traveling through a nonconductive medium such that the power signal is used to provide electrical power to operate the component.

10. The method of operating a wagering game system of claim 9, wherein the power signal comprises at least one of an electric field, a magnetic field, light, and evanescent waves.

11. The method of operating a wagering game system of claim 9, wherein the wagering game component comprises at least one of a top-box, a moving electromechanical element, and a wagering game peripheral device.

12. A wagering game system component, comprising:
a communications module operable to communicate with a wagering game machine operable to present a wagering game upon which monetary value can be wagered; and
a power module operable to receive power from the wagering game system via a power signal traveling through a nonconductive medium such that the power signal is used to provide electrical power to operate the wagering game system component.

13. The wagering game system component of claim 12, wherein the power signal comprises at least one of an electric field, a magnetic field, light, and evanescent waves.

14. The wagering game system component of claim 12, wherein the wagering game component comprises at least one of a top-box, a moving electromechanical element, and a wagering game peripheral device.

15. A wagering game system comprising:
a wagering game module operable to present a wagering game upon which monetary value can be wagered;
a peripheral device operable to receive power from the wagering game machine via a power signal traveling through a nonconductive medium; and
a power module operable to provide electrical power to operate the peripheral device through the power signal.

16. The wagering game system of claim 15, wherein the power signal comprises at least one of an electric field, a magnetic field, light, and evanescent waves.

17. The wagering game system of claim 15, wherein the wagering game component comprises at least one of a top-box, a moving electromechanical element, and a wagering game peripheral device.
